(19) United States
(12) Patent Application Publication
(10) Pub. No.: US 2015/0337938 A1
(43) Pub. Date: Nov. 26, 2015

(54) HARMONIC OR STRAIN WAVE GEARING WITH WORM GEARING PRIMARY

(71) Applicant: Cone Drive Operations, Inc., Traverse City, MI (US)

(72) Inventors: Kyle M. Jones, Frankfort, MI (US); Nathan Bildeaux, Traverse City, MI (US)

(21) Appl. No.: 14/286,162

(22) Filed: May 23, 2014

(51) Int. Cl. F16H 49/00

(52) U.S. Cl. CPC F16H 49/001

(57) ABSTRACT

A harmonic or strain wave gearing set coupled to a worm drive. By providing that a harmonic or strain wave gearing set is coupled to a worm drive, the benefit of being able to provide an input at an angle (such as a ninety-degree angle) to the output is realized along with the benefit of providing a harmonic or strain wave gearing set. Preferably, the worm drive is used as the primary, as the use of the worm drive as the primary uniquely changes the dynamics of the system, when compared to the opposite (i.e., using the harmonic or strain wave gearing as the primary). Harmonic or strain wave gearing provides a more flexible solution than a worm gear. In a system where the zero backlash is required, a split worm can be used as the input, and the harmonic or strain wave gearing would be the output member. Furthermore, a low ratio, efficient, worm gear can drive a high ratio harmonic or strain wave gearing set, thus providing a high ratio, highly efficient solution.

### BACKGROUND

The present invention generally relates to the coupling of a harmonic or strain wave gearing set to a ⁻worm drive.

Harmonic or strain wave gearing has been used and used for some time. For example, U.S. Pat. Nos. 2,906,143 and 2,983,162 disclose strain wave gearing. Both of these patents are hereby incorporated herein by reference in their entirety. Generally speaking, strain wave gearing is a motion transmitting mechanism, wherein relative motion occurs between an internal gear and a cooperating external gear. More specifically, strain wave gearing operates by deformation of a flexible gearing member having fewer gear teeth than a mating gear. The deformation combined with the difference in gear teeth creates relative motion between the flexible gearing member and the mating gear.

Worm gearing has also been used for quite some time. For example, U.S. Pat. No. 6,386,059 discloses a worm drive. A worm drive permits a ninety-degree angle between the input and output of the gear box at a variety of ratios. In contrast, harmonic or strain wave gearing provides an input and an output which are coaxial at high reduction ratios, and generally provides a more flexible solution compared to a worm gear.

### SUMMARY

An object of an embodiment of the present invention is to provide that a harmonic or strain wave gearing set is efficiently and effectively coupled to a worm drive.

By providing that a harmonic or strain wave gearing set is coupled to a worm drive, the benefit of being able to provide an input at an angle (such as a ninety-degree angle) to the output is realized along with the benefit of providing a harmonic or strain wave gearing set.

Preferably, the worm drive is used as the primary, as the use of the worm drive as the primary uniquely changes the dynamics of the system, when compared to the opposite (i.e., using the harmonic or strain wave gearing as the primary). Harmonic or strain wave gearing provides a more flexible solution than a worm gear. In a system where damping is required, the harmonic or strain wave gearing should be the output member. Furthermore, a low ratio, efficient, worm gear can drive a high ratio harmonic or strain wave gearing set, thus providing a high ratio, highly efficient solution.

Specifically, a worm gear set is mounted to, or is part of, a harmonic or strain wave gear set. In either case, the output of the worm gear and the input to the harmonic or strain wave gear are one in the same. The input to the system is the worm shaft. As the input shaft turns, the thread on the worm shaft meshes with the worm gear. This meshing creates relative motion between the worm shaft and the worm gear. The motion of the worm gear serves as the input to the harmonic or strain wave gear set. When the gear rotates, a wave generator of the harmonic or strain wave gear set rotates. Rotation of the wave generator causes a flexible gearing member to rotate and deform. This deformation causes relative motion between the flexible gearing member and a member having an internal gear. This relative motion is effectively the output of the entire gear assembly.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a top view, partially in section, of a gear system which is in accordance with an embodiment of the present invention;

FIG. 2 is a cross sectional view of the gear system shown in FIG. 1, taken along line 2-2 of FIG. 1;

FIG. 3 is a perspective view of the gear system shown in FIG. 1. showing a portion cut away to reveal the internal components; and

FIG. 4 is an exploded perspective view of the gear system shown in FIG. 1.

### DESCRIPTION OF AN ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

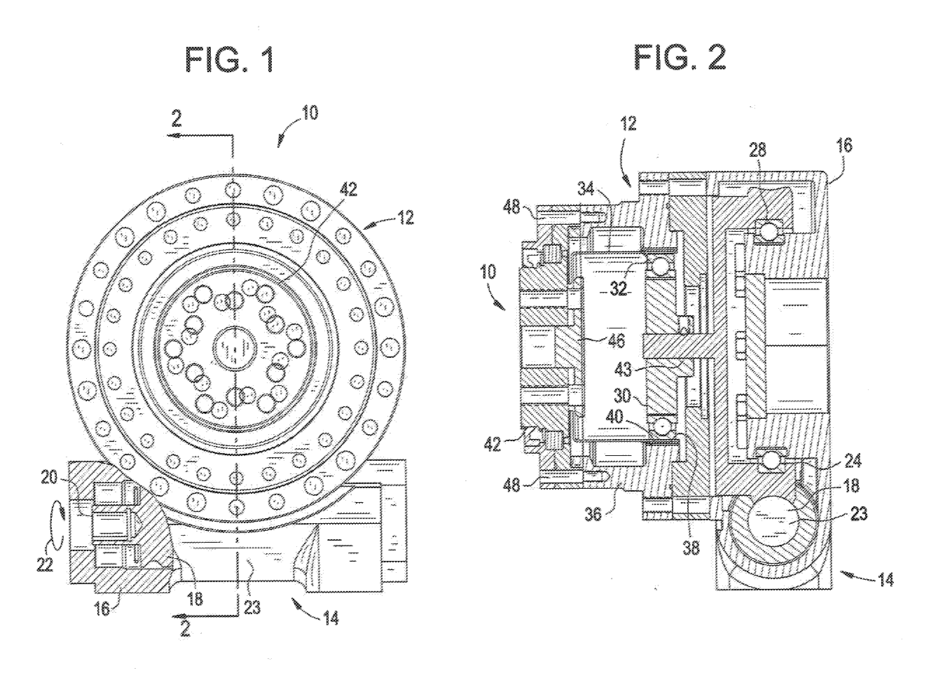

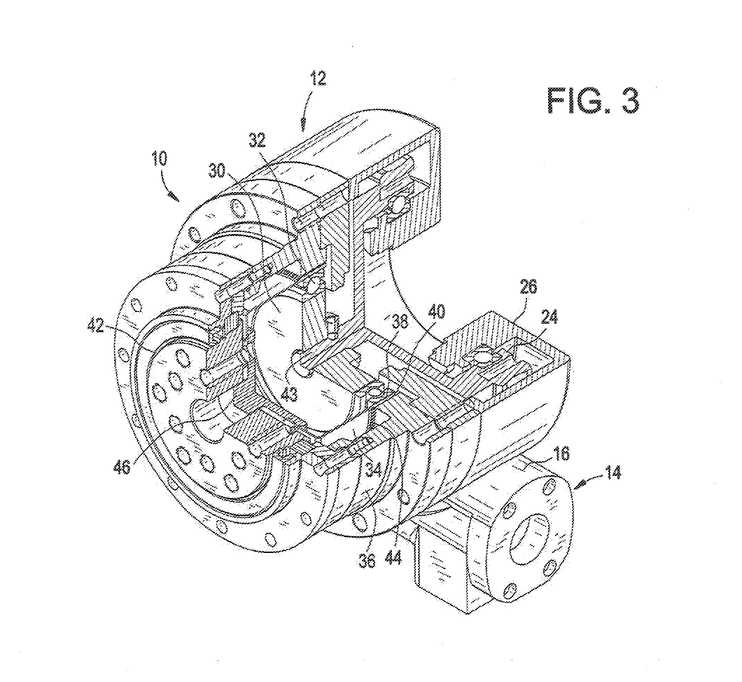

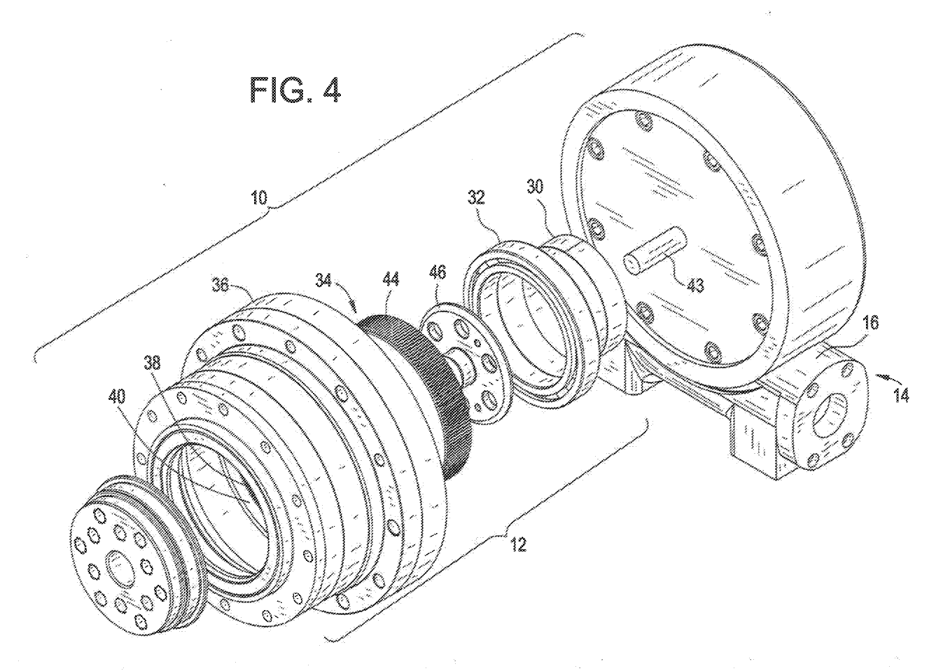

FIG. 1 is a top view, partially in section, of a gear system 10 which is in accordance with an embodiment of the present invention. FIG. 2 is a cross sectional view of the system 10, taken along line 2-2 of FIG. 1, FIG. 3 is a perspective view of the system 10, showing a portion cut away to reveal the internal components, and FIG. 4 is an exploded perspective view of the system 10.

As shown in the Figures, the gear system 10 provides that a harmonic or strain wave gearing set 12 is coupled to a worm drive gear set 14. By providing that a harmonic or strain wave gearing set 12 is effectively and efficiently coupled to a worm drive gear set 14, the benefit of being able to provide an input at an angle (such as a ninety-degree angle) to the output is realized along with the benefit of providing a harmonic or strain wave gearing set.

The worm drive gear set 14 is preferably contained in a gearbox housing 16 and comprises a worm shall 18 which has at least one input end 20 (see, for example, FIG. 1) that is configured to be engaged by a drive source (as represented by arrow 22 in FIG. 1). The drive source which engages the input end 20 and drives the worm shaft 18 can take many forms while still staying within the scope of the present invention. For example, the drive source may be a motor, a hand wheel, a planetary gear, an engine, etc. The connection between the drive source and the input end 20 can also take many forms, such as a press fit, a keyed connection, a bolted connection, a coupling such as an Oldham coupling, a spline coupling, etc. As shown in FIG. 2, the gearbox housing 16 may be provided as being multiple parts which are secured together. Regardless, the gearbox housing 16 can be made of for example, ductile iron, steel, Aluminum, or a polymer, none of which are preferred over the other as it depends on the application.

The worm drive gear set 14 may be provided as disclosed in either U.S. Pat. No. 5,237,886 or U.S. patent application Ser. No. 10/144,534 (which was published on Oct. 17, 2002 as United States Patent Publication No. 2002/0148315), wherein the worm drive gear set comprises a split worm gear which achieves zero backlash. Both U.S. Pat. No. 5,237,886 and United States Patent Publication No. 2002/0148315 are hereby incorporated herein by reference in their entireties. This zero backlash configuration is shown in FIGS. 1 and 2 of the present application, using symbol 23 as a representation.

As shown in FIG. 2, the worm shaft 18 is engaged, i.e., meshed, with a worm gear 24 at an angle (such as a ninety-degree angle) such that the axes of the two components are not parallel. The worm gear 24, like the worm shaft 18, is also disposed in a housing 26 (see FIG. 3), and this housing 26 may be integral with the gearbox housing 16 that houses the worm shaft 18, or the two housings 16, 26 may be provided as being different pieces. With regard to materials, the worm shaft 18 is preferably made from high strength steel, and the worm gear 24 is preferably made from a wear resistant bronze, but of course other materials may be chosen while still staying within the scope of the present invention. As shown in FIG. 2, a bearing 28 is preferably provided between the gearbox housing 16 and the worm gear 24,

The worm gear 24 can be configured to provide backlash or zero backlash, and the thread for threads) on the worm shaft 18 which meshes with the worm gear 24 can be a single enveloping worm, a double enveloping worm, or a cylindrical worm. Regardless, the meshing between the worm shaft 18 and the worm gear 24 provides that when the drive source drives the input end 20 of the worm shaft 18, the worm shaft 18 rotates and meshes with the worm gear 24, causing the worm gear 24 to rotate. This motion of the worm gear 24 serves as the input to the harmonic or strain wave gearing set 12.

The harmonic or strain wave gearing set 12 comprises a wave generator 30, a wave generator bearing 32, a flexible gearing member 34, a housing 36 having gearing 38 on its interior 40, and a harmonic output bearing 42 (which is effectively the output flange/shaft). The worm gear 24 is either integral with, or engaged with, the wave generator 30 such that when the worm gear 24 rotates, so does the wave generator 30. As shown in FIGS. 2-4, a wave generator coupling 43 may be provided to effectively connect the worm gear 24 to the wave generator 30. The engagement between the worm gear 24 and the wave generator 30 can take many forms, such as a press fit, a keyed connection, a bolted connection, a coupling (including an Oldham coupling), a spline coupling, etc. Alternatively, the worm gear 24 and the wave generator 30 can be one part (which is preferred), or may be connected as one part, sharing support bearings, and having no intermediate or intermediary drive shaft.

As shown in FIG. 2, the wave generator bearing 32 is disposed between the wave generator 30 and the flexible gearing member 34. The wave generator bearing 32 is configured such that rotation of the wave generator 30 causes the flexible gearing member 34 to rotate as well. As the flexible gearing member 34 rotates, it also deforms. As shown in FIG. 2, the flexible gearing member 34 may be provided as being multiple parts which are secured together. Regardless, the flexible gearing member 34 is formed of a material that allows the flexible gearing member 34 to deform during operation of the harmonic or strain wave gearing set 12. For example, the flexible gearing member 34 may be made of a ductile, tough material such as a metal or polymer.

This deformation creates relative motion between the flexible gearing member 34 and the housing 36, due to the flexible gearing member 34 having gear teeth 44 thereon which mesh with corresponding gearing (i.e., gear teeth) 38 on the internal surface 40 of the housing 36. Preferably, the flexible gearing member 34 has fewer gear teeth than does the internal surface 40 of the housing 36. The relative motion between the flexible gearing member 34 and the housing 36 is the output to the harmonic output bearing 42 which is also integral with or connected to a shaft or other structure such that the output of the harmonic output bearing 42 is effectively the output of the entire gear system 10. While the drawings show the gear teeth 38 as being provided on the internal surface 40 of the housing 36, the gear teeth 38 can be provided on a separate part which is bolted or otherwise connected to the housing 36. As such, gear teeth being provided “on the housing” should be construed liberally to include at least this variation.

As shown in FIGS. 2-4, a support plate 46 is provided as being mounted to the harmonic output bearing 42 such that the flexible gearing member 34 is disposed between the support plate 46 and the harmonic output bearing 42.

The housing 36 could be integral with the gearbox housing 16 which houses the worm gear 24, or the two housings 16, 36 can be provided as being two separate housings. The housing 36 may also include mounting throughbores 48, for mounting the housing 36 to another component or surface.

The output harmonics can be dual or single, and the harmonic style can be cup, pancake, or any other suitable style. The present invention is not limited to any particular output harmonic or strain wave gearing type or style.

With regard to materials, the wave generator bearing 32 and the harmonic output bearing 42 can each be made from any anti-friction bearing, such as ball, roller, plain, etc. wave generator 30 and the support plate 46 can be made of effectively any rigid material.

In operation, the input to the gear system 10 is the worm shaft 18. As the worm shaft 18 turns, the thread thereon meshes with the worm gear 24. This meshing thus causes relative motion between the worm shaft 18 and the worm gear 24. The motion of the worm gear 24 serves as the input to the harmonic or strain wave gear set 12. When the worm gear 24 rotates, the wave generator 30 rotates. The wave generator 30 rotation causes the flexible gearing member 34 to rotate and deform. The deformation creates relative motion between the flexible gearing member 34 and the housing 36. This relative motion is effectively the output of the overall gear system 10.

With regard to gear bearings, there could be provided a single bearing supporting both the worm gear 24 and the wave generator 30. Alternatively, multiple bearings can be used to support the worm gear 24 and the wave generator 30 such that one bearing supports one side of the worm gear 24, and the other bearing supports the other side of the worm gear 24 and the wave generator 30. Still further, multiple bearings can be used to support the worm gear 24 and the wave generator 30 such that one bearing supports one side of the worm gear 24 and the wave generator 30, and the other bearing supports the flexible gearing member 34.

The present invention provides the benefits of both a worm gear set and a harmonic or strain wave gearing set.

While a specific embodiment of the invention has been shown and described, it is envisioned that those skilled in the art. may devise various modifications without departing from the spirit and scope of the present invention.

What is claimed is:

1. A gearing system comprising: a worm gearing system; and a. harmonic or strain wave gearing system coupled with the worm gearing system, wherein the worm gearing system, serving as the input or primary gearbox, drives the harmonic or strain wave gearing system, serving as the output.

2. A gearing system as recited in claim 1, wherein the worm gearing system comprises a worm gear, and worm Shaft having at least one worm thread and at least one input end, wherein the at least one worm thread is engaged with the worm gear.

3. A gearing system as recited in claim 2, wherein the harmonic or strain wave gearing system comprises a wave generator which is either engaged with or integral with the worm gear, wherein rotation of the worm gear results in rotation of the wave generator.

4. A gearing system as recited in claim 3, wherein the harmonic or strain wave gearing system further comprises a flexible gearing member which is configured to deform and rotate in response to rotation of the wave generator.

5. A gearing system as recited in claim 4, wherein the harmonic or strain wave gearing system further comprises a housing having gearing on an interior surface, wherein the flexible gearing member comprises gearing on an exterior surface, wherein the gearing on the exterior surface of the flexible gearing member engages the gearing on the interior surface of the housing.

6. A gearing system as recited in claim 5, wherein the flexible gearing member has fewer gear teeth than does the interior surface of the housing.

7. A gearing system as recited in claim 2, wherein the worm shaft has at least one of a single enveloping worm, a double enveloping worm, and a cylindrical worm.

8. A gearing system as recited in claim 3, Wherein the wave generator and the worm gear are connected together.

9. A gearing system as recited in claim 3, wherein the wave generator and the worm gear are connected together by at least one of a press fit, a keyed connection, a bolted connection, an Oldham coupling, and a spline coupling.

10. A gearing system as recited in claim 4, further comprising a harmonic output bearing.

11. A gearing system s recited in claim 4, further comprising a support plate, and a harmonic output bearing engaged with the support plate, wherein the flexible gearing member is disposed between the support plate and the harmonic output gearing.

12. A gearing system as recited in claim 1, wherein the worm gearing system comprises a split worm gear set which provides for zero backlash.
